(19) United States
(12) Patent Application Publication
(10) Pub. No.: US 2009/0008564 A1
(43) Pub. Date: Jan. 8, 2009

(54) Modular X-Ray Detector With Single Photon Counting, Energy Sensitivity And Integration Capabilities

(75) Inventors: Adi Balan, Haifa (IL); Aurel Faibish, Sytrya (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: CMT MEDICAL TECHNOLOGIES LTD., Yoqneam Ilit (IL)

(21) Appl. No.: 11/773,450

(22) Filed: Jul. 5, 2007

(51) Int. Cl. G01T 1/20

(52) U.S. Cl. 250/366; 250/370.11

(57) ABSTRACT

Indirectly converted X-ray radiation is detected by a sensor system having a plurality of detector modules arranged with individual pedestals in a staggered configuration. Each detector module has a plurality of scintillator-diode combinations associated with respective electrical circuits for concurrent single photon counting and charge-integration. Each electrical circuit includes at least two counters and an integrator that act cooperatively to provide the concurrent single photon counting and charge-integration.

### FIELD OF THE INVENTION

The present invention relates to ionizing radiation sensors. More particularly, the present invention relates to a hybrid modular X-ray detector capable of single photon counting (SPC) and charge (signal) integration.

### BACKGROUND OF THE INVENTION

Imaging of the human body in medical applications is often achieved by detection of X-rays in scintillating materials, in which each X-ray photon is converted into a large number of visible photons. The visible photons are further transferred to an attached photo-detector (PD), which produces an electrical signal. The signal is due to the arrival of a single X-ray photon (single photon counting—SPC). In some cases, a PD output signal is a measure of the total energy generated by the incident photon. In other cases, the PD output signal reflects the integrated charge due to the arrival of several X-ray photons within a preset time interval.

Imaging requires the measurement of two-dimensional X-ray intensity distribution. This is commonly achieved by the use of position sensitive detectors. General radiography detectors use non-pixelated scintillator elements. Most such detectors use column-grown scintillator layers In the case of multiple slice computerized tomography (CT) scanners, detector arrays are built by coupling pixelated arrays of scintillator elements to respective arrays of photodiode elements. Scattered X-ray radiation leads to strong degradation of image quality; to restore image quality one has to use antiscatter grids and also to increase the radiation dose exposure.

Low Z, non-metallic septa between detector elements are used in existing pixelated scintillators to improve the light collection by the photodiode elements. The role of the septa is to confine visible light photons close to the location where the X-ray photon was stopped.

In existing photon-counting X-ray detectors, a problem may arise from small signals (smaller than a LOW threshold) generated by some photons. These photons are not accounted for, introducing an error. The LOW threshold: is typically equivalent to about 700-1000 electrons (lower is better, limited by electronic noise). In contrast, a HIGH threshold: is typically equivalent to ˜2000 electrons

Some of the X-ray photons that enter the scintillator (about 60%-80%, depending on the X-ray source anode-potential, scintillator material and thickness) are stopped within a scintillator cell. For each, at least part of the photon energy is retained within the scintillator cell and generates a stream of visible photons; the remaining energy is either emitted outside the scintillator volume (and does not contribute to the detection process) or reaches neighboring scintillator cells (the latter known as “signal sharing”). Most visible photons make their way to the PD cell attached to the scintillator cell; they are stopped and generate an electrical current. This is the input to an electronic circuit associated with the PD cell, which integrates the current generated by the arrival of one or more photons over a preset time period. There are two main detection methods: single photon counting (SPC) and charge-integration. The two are distinguished by the duration of the current integration.

### Single Photon Counting

SPC involves short duration (slightly more than the duration of the current generated by the arrival of an X-ray photon; for a CsI (Tl) scintillator ˜8 microseconds). The resulting voltage pulse (which is a measure of the total charge) is compared with a preset threshold exemplarily equivalent to a total charge of 700 electrons. Pulses with amplitude higher than the threshold are representative of detection of an X-ray photon and are counted. The advantages and weaknesses of SPC in conjunction with indirect photon detection recommend SPC be used only for low photon fluence (low radiation dose). SPC advantages include counting all photons with associated-signals above the threshold and possibility to extract coarse spectral information (one assumes that larger signals indicate photons with higher energy) through use of several thresholds. SPC disadvantages include: a) the need for threshold values to be high enough to prevent counting noise signals (low noise electronic circuitry is required; typical noise standard-deviation values are equivalent to about 70-300 electrons). The presence of very-small signals and the need to prevent noise counting leads to failure to detect photons that generate small-amplitude pulses; b) a lack of one-to-one correspondence between the signal-amplitude and the X-ray photon energy. Photons of a given energy may generate a larger signal or a smaller signal (e.g. a 45 keV photon stopped within a scintillator cell may transfer the whole energy or only 15 keV to this cell, the latter due to the escape of a 30 keV fluorescence photon; also, there is a large spread in the amount of light generated in the scintillator cell, transferred to the PD and converted into charge). Often the associated-signal may be lower than the preset (e.g. ca. 700 electrons) threshold, such that the respective photon is missed/not counted; and c) “Pile-up”, i.e. the arrival of several X-ray photons within a small time-interval that cannot be properly handled. The respective pulses overlap, resulting in generation of a number of counts smaller than the actual number of photons stopped in the scintillator-cell.

### Charge Integration

Charge integration involves long duration (typical time: 5 to 30 milliseconds). Within this time, a few to several thousand X-ray photons are sensed and the electric-charge released as they are stopped is collected, stored (typically on a capacitor) and measured. The result is seen as a measure of the number of X-ray photons stopped in the scintillator cell. Charge-integration advantages include all signals being included in or contributing to the final measurement, whether the signal-amplitude is small or large, and the fact that pile-up situations cause no ambiguities or errors. Charge-integration disadvantages include contribution of electronic-noise to the final signal, and the fact that the final signal may be an inaccurate measure of the photon-number: photons that generate signals with higher amplitude contribute more than photons (mostly low-energy photons) that generate signals of lower-amplitude.

A typical parameter that characterizes image quality is the signal to noise ratio SNR. Given a phantom feature of contrast C and N detected-photons on the corresponding feature image, the feature SNR is C×√N. In order to maximize the SNR, it is required that all or most photons which reach a scintillator cell be detected and counted.

Consequently there is a need for and it would be advantageous to have a modular X-ray detector with single photon counting, energy sensitivity and integration capabilities for use in medical imaging applications and NDT applications

### SUMMARY OF THE INVENTION

The present invention discloses devices, systems and methods for detecting X-ray radiation and forming an image therefrom In particular, the invention discloses a hybrid modular X-ray detector capable of SPC and charge integration. The detector is in essence an indirect conversion sensor (i.e. the X-ray radiation is first converted into light photons and then into electrical charge) based on a pixelated scintillator array. The basic detector module includes an antiscatter-grid, a pixelated scintillator, a back-illuminated diode array and an array of dedicated electronics-cells associated with each scintillator-diode pair.

According to the present invention there is provided an indirect conversion X-ray radiation sensor system comprising a plurality of detector modules for detecting X-ray radiation from a radiation source, each module having a module axis, the modules arranged with individual pedestals in a staggered configuration wherein the module axis points to the X-ray radiation source.

According to the present invention there is provided an X-ray radiation sensor comprising a plurality of detector modules configured to perform indirect conversion and concurrent single photon counting and charge-integration of the X-ray radiation, wherein each detector module is mounted on a separate tilting mechanism and wherein the tilting mechanisms are arranged in a staggered configuration

### BRIEF DESCRIPTION OF THE DRAWINGS

In order to better understand the present invention and appreciate its practical applications, the following figures are attached and referenced herein. Like components are denoted by like reference numerals.

It should be noted that the figures are given as examples and preferred embodiments only and in no way limit the scope of the present invention as defined in the appending Description and Claims.

FIG. 1 shows a basic detector module of the present invention;

FIG. 2A shows an embodiment of a staggered detector module configuration;

FIG. 2B shows details of a detector module mounted on a tilting pedestal;

FIG. 2C shows the problem of masking in modules not pointing directly to an X-ray source;

FIG. 3 shows microscopy pictures of septa used in a detector module of the present invention;

FIG. 4 shows schematics of the electronic circuitry for a single detector channel.

### DETAILED DESCRIPTION OF THE INVENTION

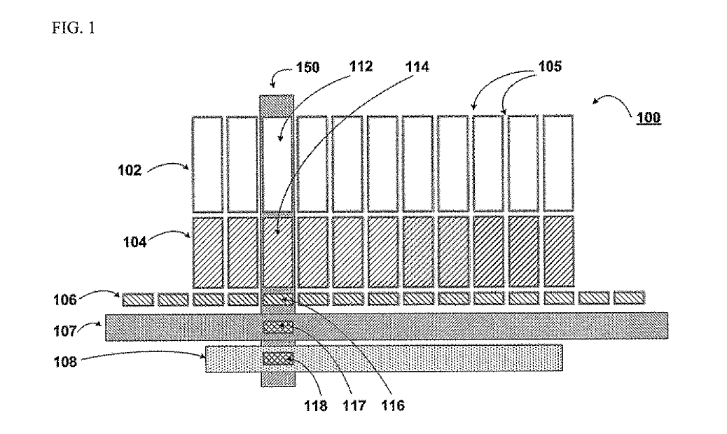

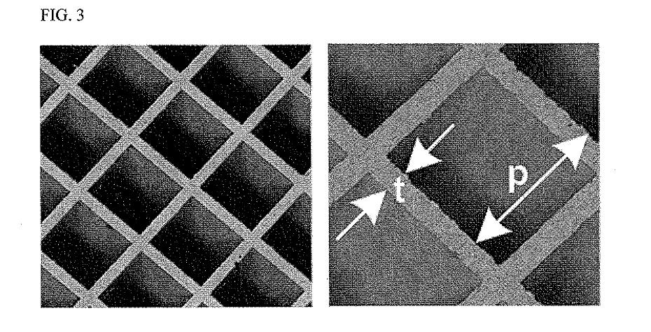

FIG. 1 shows a basic detector module 100 of the present invention. Module 100 comprises several layers: an optional anti-scatter grid layer 102 having anti-scatter cells 112, a pixelated scintillator layer 104 having scintillator pixels 114, a photodiode (PD) array layer 106, a substrate 107 and an electronics layer 108 arranged as shown. The pixilated scintillator layer includes “cells” comprised of the scintillator material and metal septa walls 105. A scintillator cell may exemplarily include CsI (Tl) as a scintillator material, surrounded by five (four sides and a top) highly reflecting Silver or Silver-plated Copper septa walls. A sixth (bottom) wall is transparent. Exemplary septa pictures are shown in FIG. 3.

PD array layer 106 includes an array of preferably back-illuminated photodiodes 116, which are registered with pixels 114 and, when present, with cells 112. Each PD is below the transparent scintillator cell floor and receives the radiated visible photons as an X-ray photon is absorbed in the scintillator. The PD absorbs the visible light and generates an electrical current. Substrate layer 107 (e.g. a printed circuit board or “PCB”) is fixedly attached to the diode array layer by e.g. soldering and includes connecting paths 117 registered with diodes 116. Paths 117 are generally electrical conductors that carry current from PDs to respective amplifiers included in an electronic circuit 118.

A column formed of elements 112, 114, 116, 117 and 118 is considered a “detector element” or “channel” 150. In the preferred embodiment, there are 128×128 such channels: each comprises its own elements 112, 114, 116, 117 and 118. Out of these, 64 channels are sacrificed so that the corresponding diodes are used as electrical connectors and apply bias to the PD array back surface (the light entry surface).

Circuit 118 integrates the current supplied by each diode as a photon is detected and then measures the charge by comparison with thresholds, see below. Layer 108 can be implemented for example as an application specific integrated circuit (ASIC), which is described in more detail below. Layer 108 is typically soldered to the substrate.

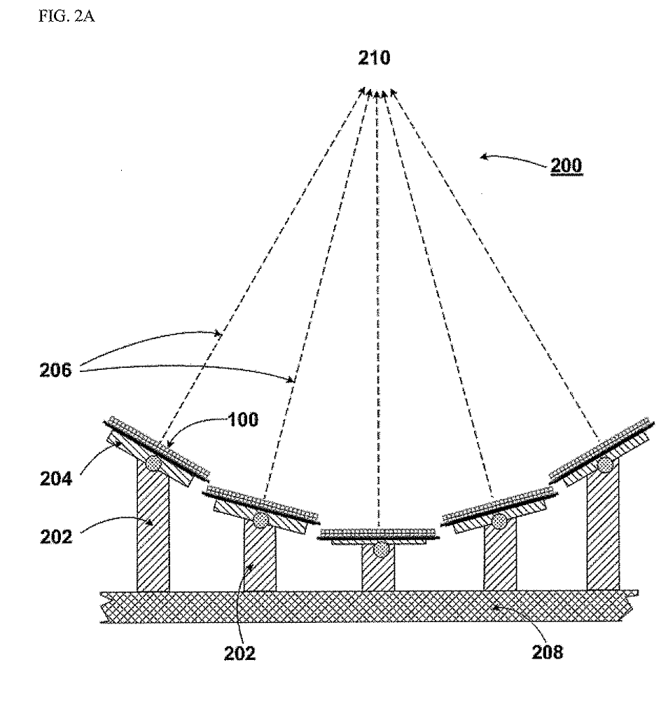

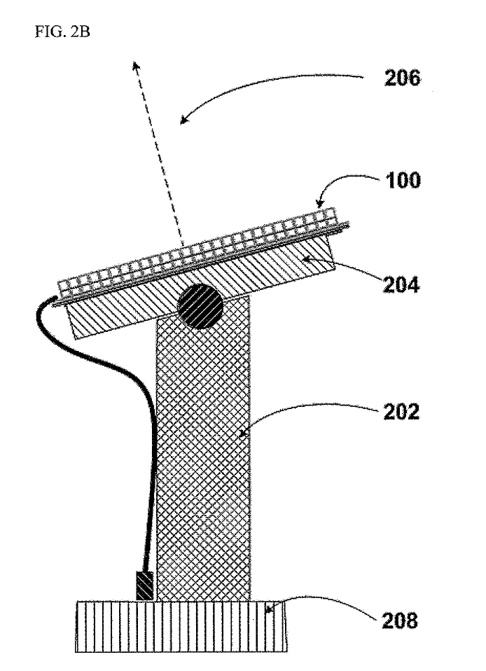

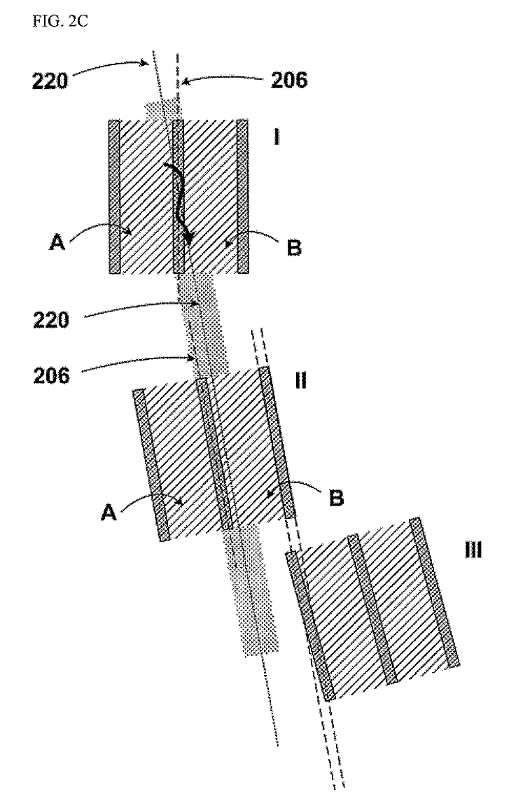

FIG. 2A shows an embodiment of a staggered detector module system 200. System 200 includes a plurality (five are shown) of detector modules 100, each module mounted on its own tilting pedestal 202 (see also FIG. 2B). The pedestals may have different heights. A pedestal 202 includes a tilt plate 204 for fixedly attaching the detector module and a base 208. Tilt plate 204 may be tilted through a predetermined angle range. The different modules in a system 200 are each tilted so that a vertical module axis 206 points towards an X-ray source focal point 210. As shown in FIG. 2C, this configuration prevents passage and attenuation of photons through adjacent scintillator cells (pixels) and the separating walls. FIG. 2C shows a detector module in two different positions I and II relative to an X-ray photon trajectory 220. In position I, detector axis 206 is non-parallel to trajectory 220. In position II, detector axis 206 is parallel to trajectory 220. Clearly, in position I, X-ray photons moving along trajectory 220 cross both cells A and B. That is, a fraction of the photon flux headed to pixel B is stopped in pixel A and in the septa (see below description of septa). When the detector module is tilted as in position II, the photons move along single cells, without crossing. Thus, X-ray attenuation in pixel A is avoided for a module pointing toward the focal point. Position III illustrates the trajectory of photons through a second detector module in the staggered arrangement of FIG. 2A. Each detector module communicates with the external world through wired means such as a flex circuit 218 connected to the module substrate and electronics.

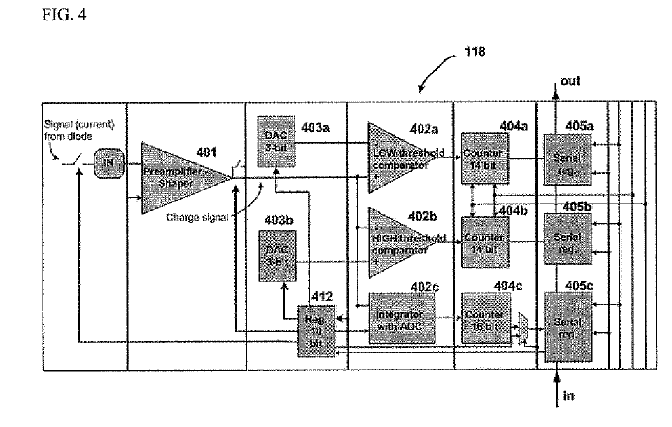

FIG. 4 shows schematics of a circuit 118 for a single detector channel. The circuit includes a preamplifier shaper 401, two (preferably 3 bit) digital to analog converter (DAC) units 403a and 403b, at least two comparators, here a low threshold comparator 402a and a high threshold comparator 402b, an integrator 402c, three counters 404a, 404b and 404c and a memory cell 412 that holds the information required by the DACs, i.e. threshold values and three serial registers 405a, 405b and 405c which allow (bit by bit) serial readout of the counter-data.

The various elements are interconnected as shown. An electrical current signal originating from the corresponding PD is input (IN) to circuit 118. The signal is amplified and shaped in preamplifier shaper 401 to obtain a voltage (proportional to the charge) signal that is delivered to comparators 402a and 402b and integrator 402c. Counter 404a and 404b, respectively associated with comparators 402a and 402b, are incremented each time the waveform amplitude is higher than preset threshold values. The content of each counter is read at the end of each acquisition cycle. Each counter value becomes the value of a pixel within an image, yielding several images/maps: one formed by values associated with counter 404a, another one formed of counter 404b values and a third one made of integrator 404c values. These values are read bit by bit by registers 405a, 405b and 405c.

### Exemplary Scintillator Array and Anti-Scatter Grid

As mentioned, in one embodiment, sensor layer 104 is made of a CsI (Tl) scintillator material embedded into a metallic rectangular grid. The CsI (Tl) scintillator displays high attenuation for X-ray photons in the 30-120 keV range and yields a generous number of visible photons for each absorbed X-ray photon (˜65000/MeV). The grid septa are typically made of silver or silver-plated copper and provide high reflectivity and prevent soft X-rays passage (e.g. Cesium or Iodine fluorescence photons) from one cell to the next. Alternatively, the septa may be made of a bismuth plus tin, silver plated grid. In a particular configuration (shown for the septa in FIG. 3), the sensor array has 128 by 128 pixels with a 250 μm pitch P separated by metallic septa (walls) with a thickness t of 30-40 μm. The scintillator height is preferably at least 0.6 mm, and most preferably around 1 mm.

Layer 104 may be prepared as follows: equally spaced trenches are cut along X and Y directions through a flat CsI (Tl) plate using a disk-saw based-system (manufactured by ADT, Advanced Dicing Technologies Ltd. Advanced Technology Center Haifa, Israel 31905, or an excimer-laser beam (Coherent Europe B.V. Smart Business Park Kanaalweg 18 A NL 3526 KL Utrecht, The Netherlands. The trench width is preferably at least 45 μm wide and the depth at least 600 μm. The grid is covered with a low viscosity optical coupling agent (e.g. optical epoxy EPOTEK-301 from, Epoxy Technology, 14 Fortune Drive, Billerica, Mass. 01821 USA placed onto the plate in registration with the trenches, and gently pushed in. The system (CsI plate and grid) is placed in an oven to let the epoxy complete a curing cycle, and then polished. Polishing removes the scintillator material above and below the grid top and bottom planes and generates shiny, flat, top and bottom surfaces.

### The Photodiode Array

In the particular configuration matching the scintillator grid and PD array above, anode connections (not shown) are equally spaced on the lower wafer surface, every 250 μm along both directions of a rectangular grid. One PD out of each group of N (e.g. N=256) PDs is replaced with an electrical contact for the cathode (the cathode surface is the back diode-surface, i.e. the entrance surface for the visible photons). Electrical connections between the PDs and the dedicated electronics circuitry can be achieved through direct attachment of the diode array to the ASIC or a suitable substrate layer.

### The Substrate

In a preferred embodiment, all PDs are equal in size and placed at uniform spacing. The contact pads of the ASIC layer may be arranged in a similar or a non-similar geometric configuration. The latter situation is imposed by the need to include electrical lines that connect the ASIC with the outside world (power lines, data lines, control signals, etc).

The substrate layer compensates for the different geometry of diode and ASIC layers and provides the electrical connections between diode pads and the corresponding ASIC pads. The substrate layer has the same outer dimensions or may be slightly wider than the diode layer. Typically, substrates materials may include organic materials (e.g. polyimide/Kapton), silicon or ceramics. Preferably, the chosen material has a thermal expansion coefficient similar to that of silicon, very low surface conductivity and mechanical stability. Such materials are well known in the art. A certain area, along the substrate perimeter is reserved for connections with the external world (typical connections are made via wire bonding).

A detector module has a finite, small size, smaller than what is required for a detector. The size is connected to the fact that production yield for diode-arrays, ASICS and substrates depends on element area and also is less than 100%. A system whose area is suitable for cath-lab applications requires tiling of several modules; one needs to place two fragile detector modules next to one another with very little gap in between (less than about 20 μm). This implies accurate edge dicing and complicated handling. Accurate dicing of diode-array edges is both difficult and expensive; also, in-plane tiling is difficult to achieve; adjacent modules that inadvertently touch in the process will almost certainly be damaged. Also, one requires narrow border-cells to compensate for the fact that each pixelated scintillator has its own external wall; effective border walls are twice the septa thickness.

The staggered (as opposed to in-plane) module arrangement prevents contact/friction between neighboring modules, minimizes damage during assembly, allows easy removal and replacement of defective modules. This type of arrangement allows for use of diode-array and substrate layers wider than the scintillator array (X-ray attenuation in these thin, low-Z layers is negligible). X-ray attenuation can be estimated for the few CsI (Tl) pixels placed below the edges of another module. There is no need for accurate dicing of these layers. The staggered mode allows for tilting the modules and minimizes the angles between the vectors “anode—module center” and the “normal to the array” at same location. The benefits include an increased solid angle/pixel and minimal shadow cast by cell A onto cell B (FIG. 2C).

In one embodiment, the spacing between the highest and lowest module along the z-axis is preferably less than 20 mm; the distance to X-ray source is about 900 mm or more.

### Hybrid Approach for Indirect-Conversion

A detector of the present invention provides accurate and error-free information on the photon-flux for operation under low-dose conditions (where both counters and the integrator participate in image generation) and under high dose-conditions (where just the integrator participates in image generation) by using a hybrid approach for the indirect conversion process. Hybrid approaches are known only for direct-conversion (see Edgar Kraft et al. “Counting and Integrating Readout for Direct Conversion X-ray Imaging Concept, Realization and First Prototype Measurements”, IEEE Transactions on Nuclear Science, April 2007, Volume 54, Issue 2, p. 383-390), but not for indirect conversion.

As used herein, “hybrid use” means the following: each method is used only under the conditions where it excels. For instance, charge-integration is used at high count-rates (more than 1000 pulses/acquisition cycle); pulse pile-up has no impact on charge integration and electronic noise is negligible when compared to radiation quantum noise. SPC is used at low count-rates—both low and high-energy photons are given equal weight, provided the associated signals are higher than the threshold. Photon counting, at low count rate, provides basic spectroscopic information (the ability to distinguish—count separately—signals representing high-energy and low-energy photons). Inventively, both counters and integrator outputs are used to estimate, (under low-dose conditions) and correct for the number of missed/uncounted photons. The method is based on the fact that ALL pulses do contribute to the final value of the integrator.

The integrator integrates the diode-current for the whole duration of the acquisition cycle (typically 5 msec<T<30 msec, where T is the cycle duration). The result of the integration can also be expressed as a sum of the electrical-charges collected with the arrival of each photon:

$$\begin{matrix}{\int }_{0}^{T} i ( t ) d t = {\sum }_{n} {Q}_{n} \\ = {\sum }_{n} ( {Q}_{n} < {Q}_{LOW} ) + {\sum }_{n} ( {Q}_{LOW} < {Q}_{n} < {Q}_{HIGH} ) + \\ {\sum }_{n} ( {Q}_{HIGH} < {Q}_{n} < {Q}_{MAX} )\end{matrix}$$

Where i(t) is the diode current that enters the electrical circuit (dark current contribution may be neglected), Qₙ is the charge-signal associated with the n'th X-ray photon, Q_{LOW} is the charge-signal equivalent to the LOW threshold defined above (e.g. the mean charge-signal associated with a 30 keV photon whose energy is fully converted to visible photons within the scintillator cell), Q_{HIGH} is the charge-signal equivalent to the HIGH threshold defined above (e.g. the mean charge-signal associated with a 60 keV photon whose energy is fully converted to visible photons within the scintillator cell) and Q_{MAX} is the charge-signal equivalent to the highest energy photons in a given application (e.g. the mean charge-signal associated with a 100 keV photon when the X-ray source is operated with anode potential of 100 kVp). The expression on the right separates the various contributions according to the amount of charge brought in by the X-ray photons.

Assuming that the pulse-amplitude distribution is uniform, from zero to the maximum amplitude Q_{MAX}, one obtains:

$${N}_{VERYLOW} = \frac{2}{{Q}_{LOW}} \cdot INT - ( 1 + \frac{{Q}_{HIGH}}{{Q}_{LOW}} ) \cdot {N}_{LOW} + ( 1 - \frac{{Q}_{MAX}}{{Q}_{LOW}} ) \cdot {N}_{HIGH}$$

where N_{VERYLOW} is the estimated number of X-ray photons with associated small signals, N_{LOW} is the number of pulses higher than the LOW THRESHOLD, N_{HIGH} is the number of pulses higher than the HIGH THRESHOLD and

$$INT = {\sum }_{n} {Q}_{n}$$

is the integrator output. For the particular values suggested here, i.e. the charge Q_{MAX} associated with the energy a 30 keV photon imparts to the scintillator cell, the charge Q_{HIGH} associated with the energy a 60 keV photon imparts to the scintillator cell and the charge Q_{MAX} associated with the maximum energy a 100 keV photon can donate to the same scintillator cell, the estimated number of X-ray photons with associated small-signals is N_{VERYLOW}:

N_{VERYLOW}=0.067−INT−3·N_{LOW}−2.3N_{HIGH}

from which one can obtain the total number of detected photons N_{ALL}:

N_{ALL}=N_{LOW}+N_{VERYLOW}

which is a better estimate of the total number of detected photons than N_{LOW}. One can now generate an image based on N_{ALL}. This image will provide significantly better visibility for small features under low-dose exposure than the image based on N_{LOW} because N_{ALL}>N_{LOW}.

Note that the method is further “hybrid” in the sense that it makes correlated use of the integrator data INT and the two counter-data N_{LOW} and N_{HIGH} in order to reveal additional information, not existing in prior art systems. This information is the number of photons sensed but not counted, as they are associated with signals of amplitude lower than the lowest threshold.

In general, the relationship between the four quantities N_{VERYLOW}, N_{LOW}, N_{HIGH} and INT can be written as:

N_{VERYLOW}=β₀·INT+β₁·N_{LOW}+β₂·N_{HIGH}

with the three parameters β above being 0.067, −3 and −2.3. In practice one needs to determine the three parameters β for each channel within each detector-module. This is done as follows:
1. The procedure is performed prior to assembly of the scintillator and antiscatter grid on top of the diode array.
2. The detector module is positioned to face a uniform, calibrated, pulsed, visible-light source (such as Model LE-1SC Modulated LED Source supplied by WT&T of 4140 Brian Pierrefonds, Quebec H9J 1X9, Canada).
3. The light source is operated such that it irradiates each PD-cell with a preset number of pulses/cycle as, for example, in the following table:

| Amplitude/ | | | |
|---|---|---|---|
| Number | 0.5 × Q_{LOW} | Q_{LOW} | Q_{HIGH} |
| Number of visible-light pulses | 0 | 0 | 10 |
| on each channel within a single | 0 | 10 | 0 |
| cycle | 0 | 10 | 10 |
| | 4 | 10 | 0 |
| | 5 | 5 | 2 |

4. For each acquisition one reads the counters' and integrator values.
5. The values are used to estimate the three β parameters for each channel, using a least mean squares method, as well known in the art.
6. The estimated parameters are stored in dedicated registry cell, typically on an external computer-board that receives the TNT and COUNTER-s values. associated with each channel so that the quantities N_{VERYLOW} can be estimated on-line.

In summary, we use a scintillator-diode combination for concurrent single photon counting and charge-integration in medical imaging applications and NDT applications. A modular X-ray sensor uses a scintillator to convert X-ray energy into visible light and further detect the light using attached photodiodes. Electrical pulses obtained by integration of the photodiode current are sensed and counted by at least two counters according to pulse amplitude. SPC is used primarily while the photon rate is low; in this mode the integration channel provides additional information and ability to estimate the number of photons associated with very low-amplitude pulses (lower than the lowest channel threshold). The charge-integration channel takes over at high fluence where pile-up situations occur. Inventively, we have a hybrid use of counters and integrator for the same pixel and within same data acquisition cycle.

All publications and patents mentioned in this specification are incorporated herein in their entirety by reference into the specification, to the same extent as if each individual publication or patent was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

1. An indirect conversion X-ray radiation sensor system comprising a plurality of detector modules for detecting X-ray radiation from a radiation source, each module having a module axis, the modules arranged with individual pedestals in a staggered configuration wherein the module axis points to the X-ray radiation source, wherein each detector module is further characterized by having a plurality N of detector channels, each channel including a registered structure of a scintillator cell coupled to a respective photodiode and to a respective electronic circuit and wherein the respective electronic circuit is dedicated to handling the electronic signals supplied only by the respective photodiode.

2. The X-ray sensor of claim 1, wherein each pedestal has a tilting plate having a detector module mounted thereon, the tilting plate used to point the detector module axis to the X-ray source.

3. The X-ray sensor of claim 2, wherein the pedestals have different heights.

4. The X-ray sensor of claim 1, wherein, in each registered structure, the electronic circuit is adjacent to the photodiode and connected to the photodiode by a single signal-input.

5. The X-ray sensor of claim 4, wherein the electronic circuit is configured to perform concurrent single photon counting and charge-integration of the X-ray radiation.

6. The X-ray sensor of claim 5, wherein the concurrent single photon counting and charge-integration is enabled by two counters and an integrator included in the respective electronic circuit.

7. An X-ray radiation sensor comprising a plurality of detector modules configured to perform indirect conversion and concurrent single photon counting and charge-integration of the X-ray radiation, wherein each detector module is mounted on a separate tilting mechanism and wherein the tilting mechanisms are arranged in a staggered configuration, wherein each detector module is further characterized by having a plurality N of detector channels, each channel including a registered structure of a scintillator cell coupled to a respective photodiode and to a respective electronic circuit, wherein the respective electronic circuit is dedicated to handling the electronic signals supplied only by the respective photodiode. cm 8. (canceled)

9. The X-ray radiation sensor of claim 7, wherein the respective electronic circuit has at least a HIGH counter, a LOW counter and an integrator that act cooperatively to provide the concurrent single photon counting and charge-integration.

10. (canceled)

11. The X-ray sensor of claim 1, wherein each photodiode has a single undivided sensing area.

12. The X-ray sensor of claim 7, wherein each photodiode has a single undivided sensing area.

13. The X-ray sensor of claim 7, wherein, in each registered structure, the electronic circuit is adjacent to the photodiode and connected to the photodiode by a single signal-input.
